(19) United States
(12) Patent Application Publication
(10) Pub. No.: US 2024/0322495 A1
(43) Pub. Date: Sep. 26, 2024

(54) Electrical Connector

(71) Applicants: QUN JIA, Yangzhou City (CN); JIANGSU DONGBEI COMMUNICATION TECHNOLOGY CO.,LTD, Yangzhou City (CN)

(72) Inventor: QUN JIA, Yangzhou City (CN)

(21) Appl. No.: 18/613,103

(22) Filed: Mar. 22, 2024

(30) Foreign Application Priority Data
Mar. 23, 2023 (CN) 202320582482 .0

(51) Int. Cl. H01R 13/6477; H01R 13/04; H01R 13/516; H01R 13/52

(52) U.S. Cl. CPC H01R 13/6477; H01R 13/04; H01R 13/516; H01R 13/5202; H01R 13/5205

(57) ABSTRACT

This application relates to the field of communication connector technology, specifically to an electrical connector. The electrical connector improves the structural design by incorporating perforated structures to provide an air medium on the insulator. By exploiting the difference in dielectric coefficients between the air medium and the insulator, the characteristic impedance of the electrical connector can be adjusted to ensure that the return loss of signal transmission through the electrical connector meets expectations, thereby satisfying the transmission requirements of high-bandwidth signals.

### CROSS-REFERENCE TO RELATED APPLICATIONS

This application claims the priority of China Patent Application No. 202320582482.0 filed on Mar. 23, 2023, in the State Intellectual Property Office of China, the disclosure of which is incorporated herein by reference.

### BACKGROUND OF THE INVENTION

### Field of the Invention

This application pertains to the field of electronic device technology, specifically relating to a type of electrical connector capable of ensuring that the return loss of transmitted signals meets expectations.

### Descriptions of the Related Art

Electrical connectors can be utilized in electronic devices as bridges for signal transmission. When electrical connectors applied in electronic devices, electrical connectors serve as bridges for signal transmission between circuit boards (or cables) and cables, facilitating communication between circuit boards (or cables) and cables. With the development of electronic devices, electrical connectors are increasingly required to transmit high-bandwidth signals.

However, due to structural issues in electrical connectors, technical problems such as mismatches in characteristic impedance exist, resulting in poor transmission performance of high-bandwidth signals. For example, after testing, electrical connectors like the three-part hollow needle head coaxial cable connector exhibit relatively low return loss, significantly exceeding −25 dB, thus failing to meet the operational requirements under current high-bandwidth conditions.

It should be noted that return loss is a crucial indicator for digital cable products. Return loss refers to the ratio of retroreflection power loss to flection power at the cable connection point. The higher the return loss, the better. Higher return loss has a lesser impact on signal transmission.

Therefore, addressing the aforementioned shortcomings and improving the structural design of electrical connectors to allow for adjustment of their characteristic impedance values, thereby ensuring that the return loss of signal transmission meets expectations, is a pressing issue for professionals in the field.

### SUMMARY OF THE INVENTION

In view of the drawbacks of the prior art mentioned above, the present application provides an electrical connector. The electrical connector is able to improve the structural design to allow the characteristic impedance of the electrical connector can be adjusted to ensure that the return loss of signal transmission through the electrical connector meets expectations, thereby satisfying the transmission requirements of high-bandwidth signals.

In view of the drawbacks of the prior art mentioned above, the present application provides an electrical connector comprising an electrical connector body; and a pin base component, the pin base component comprising a pin base, a pin, and a first pin base insulator, wherein the pin base has an pin base internal space, the first pin base insulator has a first pin base insulator through-hole structure and a first pin base insulator perforated structure, the pin base is joined to the electrical connector body, and the pin and the first pin base insulator are respectively installed to position the first pin base insulator within the pin base internal space, allowing the pin to extend outward through the first pin base insulator via the first pin base insulator through-hole structure, wherein the first pin base insulator perforated structure provides an air medium to achieve the expected return loss of the signal transmitted by the pin by exploiting the difference in dielectric coefficients between the air medium and the first pin base insulator.

Preferably, the electrical connector said above, wherein the first pin base insulator perforated structure comprises a plurality of first pin base insulator perforated sub-structures distributed around the first pin base insulator through-hole structure.

Preferably, the electrical connector said above, wherein the plurality of first pin base insulator perforated sub-structures are individually separated from the first pin base insulator through-hole structure, and the separation distances among the plurality of first pin base insulator perforated sub-structures and the first pin base insulator through-hole structure are substantially equal.

Preferably, the electrical connector said above, wherein the plurality of first pin base insulator perforated sub-structures are separated from each other, and the separation distances among the plurality of first pin base insulator perforated sub-structures are substantially equal.

Preferably, the electrical connector said above, wherein the plurality of first pin base insulator perforated sub-structures are circular holes, elliptical holes, polygonal holes, fan-shaped holes, or irregularly shaped holes.

Preferably, the electrical connector said above, further comprising a pin base component waterproof gasket located between the pin base and the electrical connector body to prevent water from penetrating into the pin base internal space via the gap between the pin base and the electrical connector body.

Preferably, the electrical connector said above, wherein the pin base component further comprises a second pin base insulator, the second pin base insulator having a second pin base insulator through-hole structure, wherein the pin base is capable of accommodating the second pin base insulator, positioning the second pin base insulator within the pin base internal space, and allowing the pin to extend outward through the second pin base insulator via the second pin base insulator through-hole structure, wherein there exists a difference in dielectric coefficients between the first pin base insulator and the second pin base insulator, thereby enabling the pin to transmit signals with the expected return loss.

Preferably, the electrical connector said above, wherein the pin base component further comprises a third pin base insulator, the third pin base insulator comprising a third pin base insulator through-hole structure, wherein the pin base is capable of accommodating the third pin base insulator, positioning the third pin base insulator within the pin base internal space, and allowing the pin to extend outward through the third pin base insulator via the third pin base insulator through-hole structure, wherein there exists a difference in dielectric coefficients among the third pin base insulator, the first pin base insulator and the second pin base insulator, thereby enabling the pin to transmit signals with the expected return loss.

Preferably, the electrical connector said above, wherein the material of the first pin base insulator is HIPS (High impact polystyrene) with a dielectric coefficient of 2.5, wherein the material of the second pin base insulator is polytetrafluoroethylene with a dielectric coefficient of 2.1; and the material of the third pin base insulator is ABS (Acrylonitrile Butadiene Styrene) with a dielectric coefficient of 2.7.

Preferably, the electrical connector said above, configured to be used with a cable, further comprising a cable component, and the cable component comprises a cable base, and the cable base comprises a cable base internal space, wherein the cable base is joined to the electrical connector body and the cable is installed, allowing the cable to enter the electrical connector body from the cable base internal space and electrically connect to the pin to provide the signals.

Preferably, the electrical connector said above, wherein the cable base further comprises a cable base clamping structure, the cable base clamping structure clamps and positions the cable to achieve the installation of the cable.

Preferably, the electrical connector said above, further comprising a cable component waterproof gasket located between the cable base and the electrical connector body to prevent water from penetrating into the cable base internal space via the gap between the cable base and the electrical connector body.

Compared to existing technology, the electrical connector improves the structural design by incorporating perforated structures to provide an air medium on the insulator. By exploiting the difference in dielectric coefficients between the air medium and the insulator, the characteristic impedance of the electrical connector can be adjusted to ensure that the return loss of signal transmission through the electrical connector meets expectations, thereby satisfying the transmission requirements of high-bandwidth signals.

### BRIEF DESCRIPTION OF THE DRAWINGS

The above and other aspects, has and other advantages of the present invention will be more clearly understood from the following detailed description taken in conjunction with the accompanying drawings, in which:

FIG. 1 is a three-dimensional schematic diagram of the electrical connector viewed from a first angle according to an embodiment of the present application.

FIG. 2 is a three-dimensional schematic diagram of the electrical connector viewed from a second angle according to an embodiment of the present application.

FIG. 3 is a side view schematic diagram of an embodiment of the electrical connector according to the present application.

FIG. 4 is a front view schematic diagram of an embodiment of the electrical connector according to the present application.

FIG. 5 is a rear view schematic diagram of an embodiment of the electrical connector according to the present application.

FIG. 6 is a sectional schematic diagram of an embodiment of the electrical connector according to the present application.

FIG. 7 is a three-dimensional schematic diagram of some components of the electrical connector viewed from a first angle according to an embodiment of the present application.

FIG. 8 is a three-dimensional schematic diagram of some components of the electrical connector viewed from a second angle according to an embodiment of the present application.

FIG. 9 is a sectional schematic diagram of some components of an embodiment of the first pin base insulator according to the present application.

FIG. 10 is a sectional schematic diagram of some components of an embodiment of the first pin base insulator according to the present application.

FIG. 11 is a sectional schematic diagram of some components of an embodiment of the first pin base insulator according to the present application.

FIG. 12 is a sectional schematic diagram of some components of an embodiment of the first pin base insulator according to the present application.

FIG. 13 is a sectional schematic diagram of some components of an embodiment of the first pin base insulator according to the present application.

FIG. 14 is a sectional schematic diagram of some components of an embodiment of the first pin base insulator according to the present application.

FIG. 15 is a sectional schematic diagram of some components of an embodiment of the first pin base insulator through-hole structure according to the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

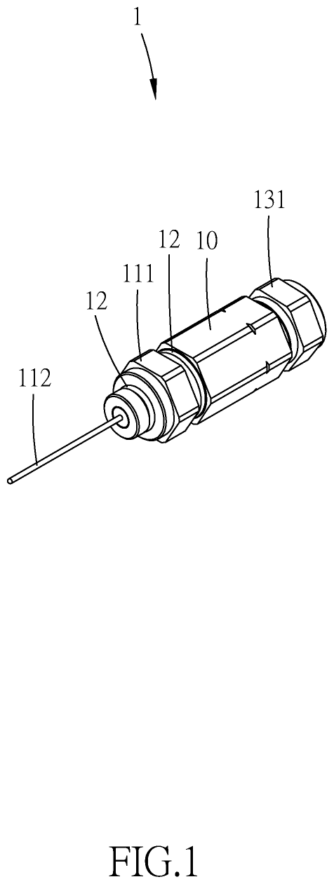

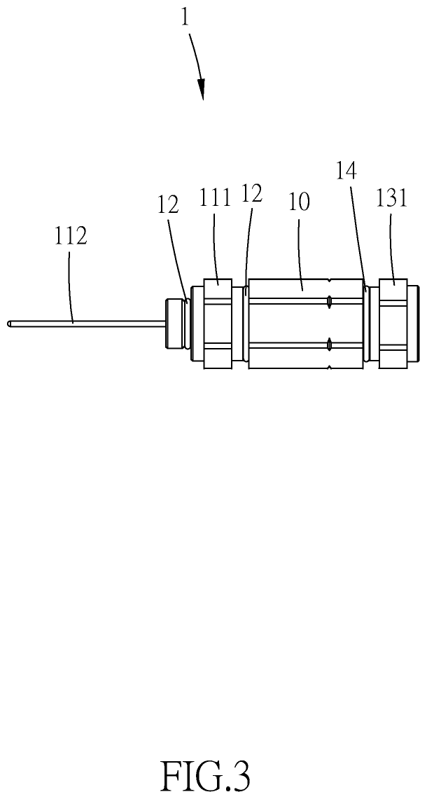

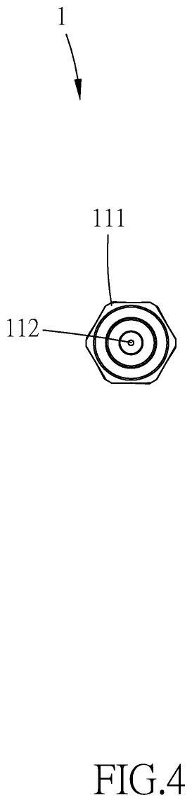

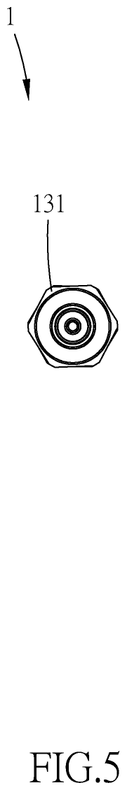

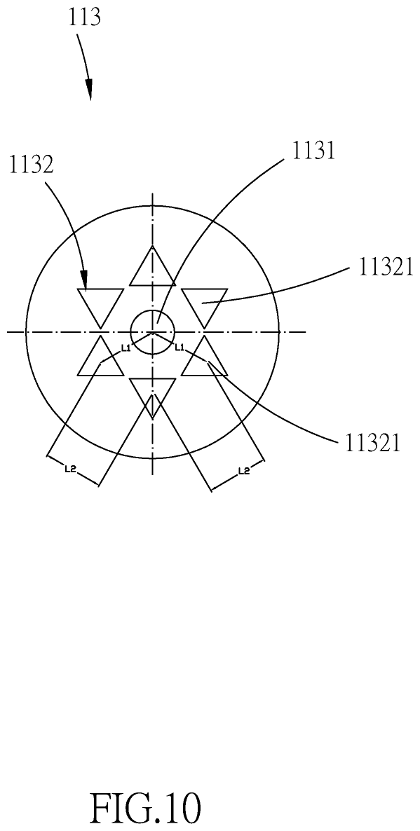

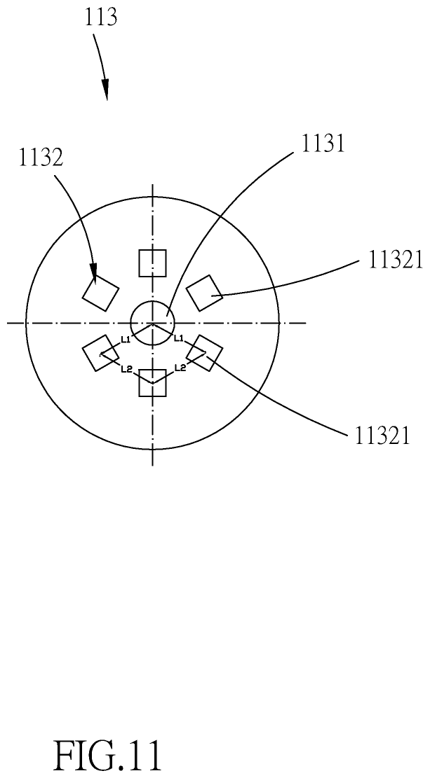

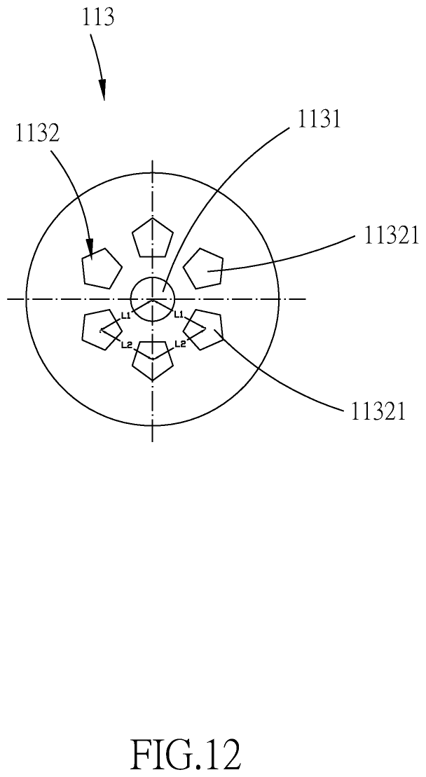

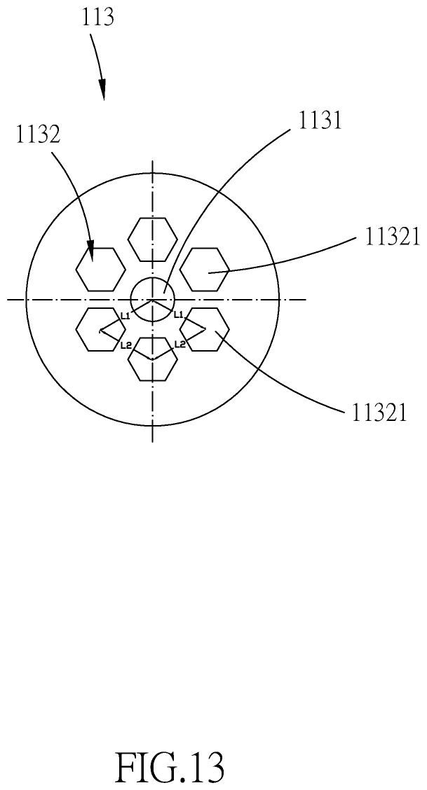

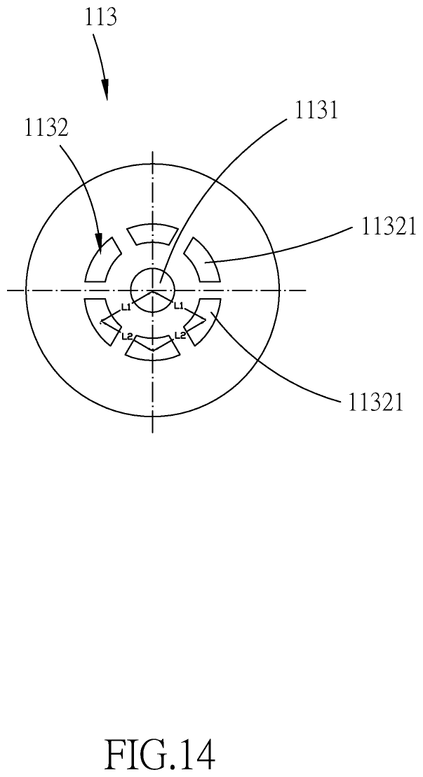

Regarding the technical concept of the electrical connector of the present application, please refer to FIGS. 1 to 15 for explanations of embodiments of the three-part hollow needle head coaxial cable connector.

In the embodiments shown in FIGS. 1 to 8, the electrical connector 1 can be equipped with a cable 2. The electrical connector 1 comprises: an electrical connector body 10, a pin base component 11, a pin base component waterproof gasket 12, a cable component 13, and a cable component waterproof gasket 14.

The pin base component 11 comprises a pin base 111, a pin 112, and a first pin base insulator 113. The first pin base insulator 113 comprises a first pin base insulator through-hole structure 1131 and a first pin base insulator perforated structure 1132.

The pin base 111 comprises a pin base internal space 1110. As shown in FIGS. 1 to 3 and FIGS. 6 to 8, the pin base 111 can be joined to the electrical connector body 10 and can be individually equipped with the pin 112 and the first pin base insulator 113 to place the first pin base insulator 113 within the pin base internal space 1110, allowing the pin 112 to extend outward through the first pin base insulator 113 via the first pin base insulator through-hole structure 1131 from the electrical connector body 10. The first pin base insulator perforated structure 1132 provides an air medium, and by exploiting the difference in dielectric coefficients between the air medium and the first pin base insulator 113, the characteristic impedance of the electrical connector is adjusted, ensuring that the return loss of the signal transmitted by the pin 112 meets expectations.

In the present application, the electrical connector 1 can be a three-part hollow needle head coaxial cable connector, and can be equipped with a cable 2, such as a coaxial cable. It should be noted that, according to SCTE 125 2020, the return loss of the electrical connector 1 is less than −25 dB in the frequency range of 5-1794 MHz, ensuring that the return loss of the signal transmitted by the electrical connector meets expectations. Additionally, according to SCTE 144 2017, the insertion loss of the electrical connector 1 is less than-0.25 dB in the frequency range of 5-1794 MHz, ensuring that the insertion loss of the signal transmitted by the electrical connector meets expectations to meet the high-bandwidth signal transmission applications of the data-over-cable service interface specification (DOCSIS 4.0) standard.

In the above embodiments, to adjust the characteristic impedance of the electrical connector, the first pin base insulator perforated structure 1132 comprises a plurality of first pin base insulator perforated sub-structures 11321. The plurality of first pin base insulator perforated sub-structures 11321 are distributed around the first pin base insulator through-hole structure 1131 according to a predetermined rule. However, the number of the first pin base insulator perforated sub-structures 11321 is not limited to multiple, and the number of the first pin base insulator perforated sub-structures 11321 can be just one.

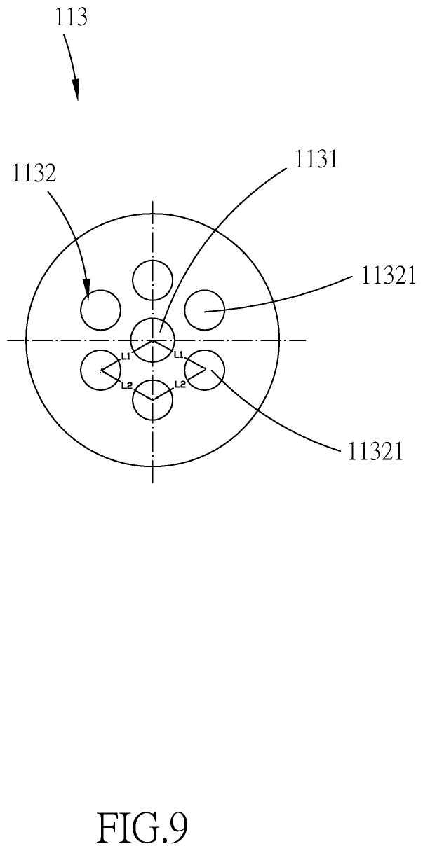

Regarding the distribution rule of the plurality of first pin base insulator perforated sub-structures 11321, it should be noted that, as shown in FIGS. 9 to 14, the plurality of first pin base insulator perforated sub-structures 11321 are individually separated from the first pin base insulator through-hole structure 1131, and the separation distances L1 among the plurality of first pin base insulator perforated sub-structures 11321 and the first pin base insulator through-hole structure 1131 are substantially equal. Furthermore, the plurality of first pin base insulator perforated sub-structures 11321 are individually separated from each other, and the separation distances L2 among the plurality of first pin base insulator perforated sub-structures 11321 are substantially equal. Therefore, the plurality of first pin base insulator perforated sub-structures 11321 are distributed around the first pin base insulator through-hole structure 1131 according to a predetermined rule, ensuring that the force on the pin 112 passing through the first pin base insulator through-hole structure 1131 is balanced to enhance the electrical performance of the electrical connector 1, ensuring that the return loss of the signal transmitted by the pin 112 meets expectations.

Optionally, as shown in FIGS. 9 to 14, the plurality of first pin base insulator perforated sub-structures 11321 can be circular holes, elliptical holes, polygonal holes, or fan-shaped holes. However, this is not limiting, as the plurality of first pin base insulator perforated sub-structures 11321 can also be irregularly shaped holes.

As shown in FIGS. 1 to 3 and FIGS. 6 to 8, the pin base component waterproof gasket 12 is positioned between the pin base 111 and the electrical connector body 10 to provide waterproofing and to prevent water from infiltrating the pin base internal space 1110 through gaps between the pin base 111 and the electrical connector body 10, thus imparting waterproofing properties to the electrical connector 1. Optionally, the material of the pin base component waterproof gasket 12 is silicone rubber.

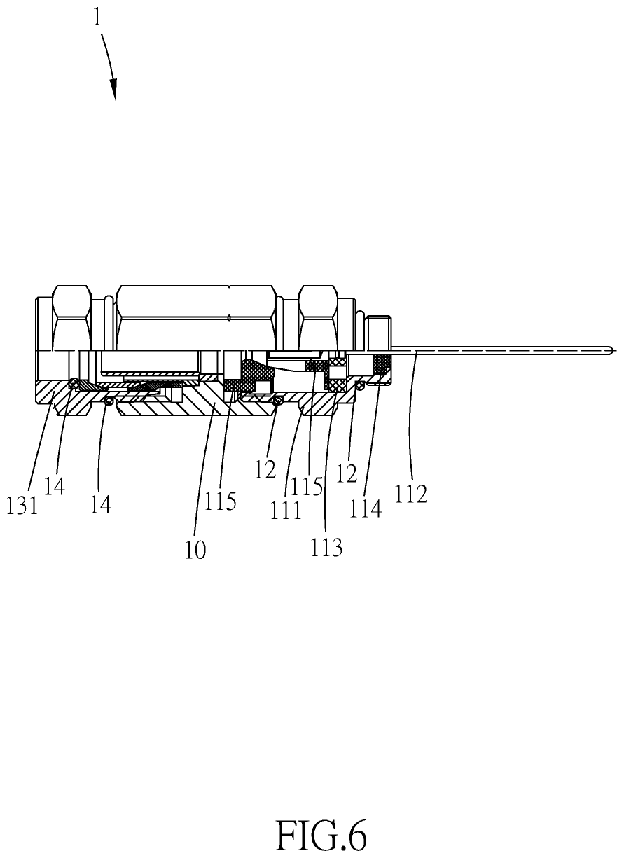

In the embodiments shown in FIGS. 6 to 8, the pin base component 11 further comprises a second pin base insulator 114 and a third pin base insulator 115. The second pin base insulator 114 comprises a second pin base insulator through-hole structure 1141. The third pin base insulator 115 comprises a third pin base insulator through-hole structure 1151.

In the above embodiments, to improve the return loss of the transmitted signal, the pin base 111 can also accommodate the second pin base insulator 114 and the third pin base insulator 115 to position the second pin base insulator 114 and the third pin base insulator 115 within the pin base internal space 1110, allowing the pin 112 to extend outward through the second pin base insulator through-hole structure 1141 and the third pin base insulator through-hole structure 1151. Importantly, the dielectric constant of the first pin base insulator 113 differs from that of the second pin base insulator 114, and the dielectric constant of the third pin base insulator 115 differs from that of both the first pin base insulator 113 and the second pin base insulator 114, enabling the return loss of the signal transmitted by the pin 112 to meet expectations.

Optionally, the material of the first pin base insulator 113 is HIPS (High impact polystyrene) with a dielectric constant of 2.5; the material of the second pin base insulator 114 is polytetrafluoroethylene with a dielectric constant of 2.1; and the material of the third pin base insulator 115 is ABS (Acrylonitrile Butadiene Styrene) with a dielectric constant of 2.7. Through testing, the electrical connector 1 achieves a return loss significantly less than −25 dB within the frequency range of 5-1794 MHz, thereby realizing the advantage of improving the overall performance of the electrical connector.

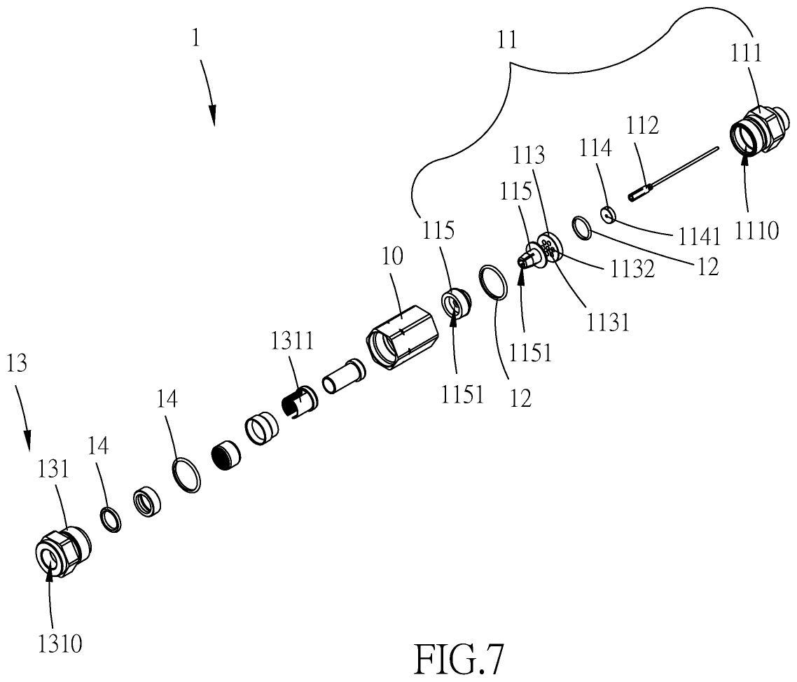

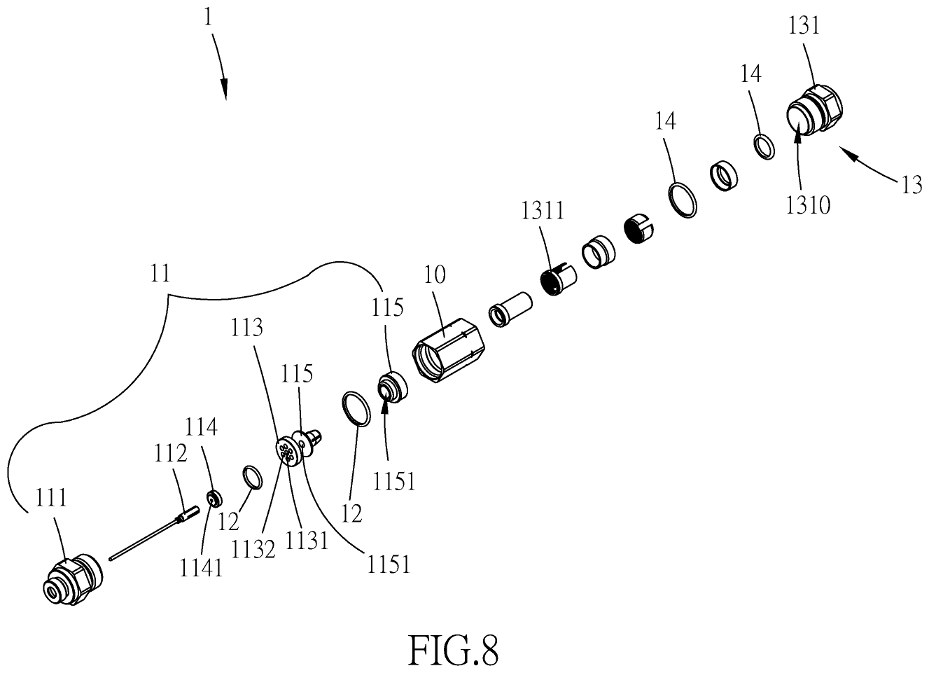

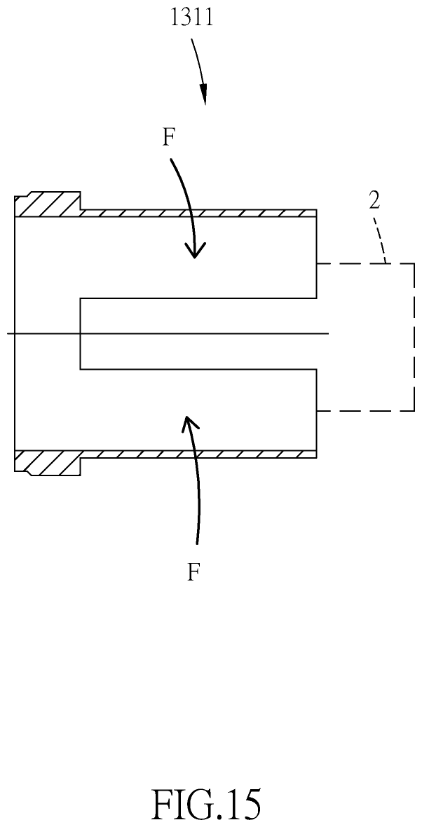

In the embodiment shown in FIGS. 7 to 8, the cable component 13 comprises a cable base 131. The cable base 131 has a cable base internal space 1310 and a cable base clamping structure 1311. The cable base 131 is joined to the electrical connector body 10. As depicted in FIG. 15, the cable base clamping structure 1311 provides clamping force to clamp and position the cable 2 for installation, allowing the cable 2 to enter the electrical connector body 10 from the cable base internal space 1310 and electrically connect to the pin 112 for signal transmission.

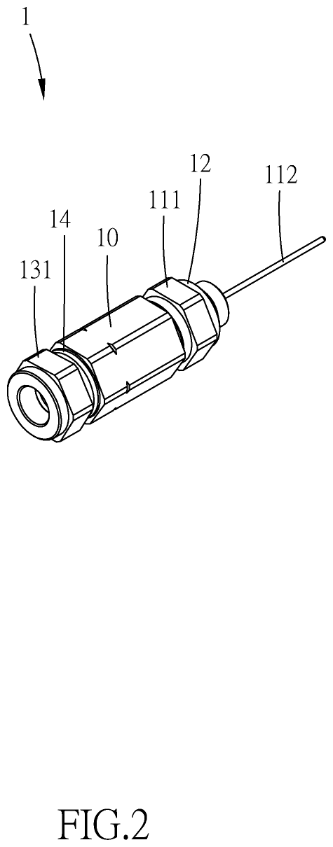

As shown in FIGS. 2 to 3 and 6 to 8, the waterproof gasket 14 of the cable component is positioned between the cable base 131 and the electrical connector body 10 to provide waterproofing. This prevents water from infiltrating the cable base internal space 1310 through the gap between the cable base 131 and the electrical connector body 10, thereby imparting waterproof performance to the electrical connector 1. Optionally, the material of the waterproof gasket 14 may be silicone rubber.

It should be noted that the electrical connector of the present application can omit certain components and is not limited to the embodiments described above.

For example, the electrical connector of the present application may optionally include only the following components: an electrical connector body and a pin base component. The pin base component comprises a pin base, a pin, and a first pin base insulator. The pin base comprises a pin base internal space, and the first pin base insulator comprises a first pin base insulator through-hole structure and a first pin base insulator perforated structure. The pin base is joined to the electrical connector body, and the pin and the first pin base insulator are respectively installed, so that the first pin base insulator is located within the pin base internal space, and the pin extends outward from the electrical connector body through the first pin base insulator through-hole structure. The first pin base insulator perforated structure provides an air medium, utilizing the difference in dielectric constants between the air medium and the first pin base insulator to ensure that the pin transmits signals with the expected return loss.

In summary, the electrical connector of this application improves the structural design by incorporating perforated structures to provide an air medium on the insulator. By exploiting the difference in dielectric coefficients between the air medium and the insulator, the characteristic impedance of the electrical connector can be adjusted to ensure that the return loss of signal transmission through the electrical connector meets expectations, thereby satisfying the transmission requirements of high-bandwidth signals.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, comprising:
an electrical connector body; and
a pin base component, the pin base component comprising a pin base, a pin, and a first pin base insulator, wherein the pin base has an pin base internal space, the first pin base insulator has a first pin base insulator through-hole structure and a first pin base insulator perforated structure, the pin base is joined to the electrical connector body, and the pin and the first pin base insulator are respectively installed to position the first pin base insulator within the pin base internal space, allowing the pin to extend outward through the first pin base insulator via the first pin base insulator through-hole structure, wherein the first pin base insulator perforated structure provides an air medium to achieve the expected return loss of the signal transmitted by the pin by exploiting the difference in dielectric coefficients between the air medium and the first pin base insulator.

2. The electrical connector of claim 1, wherein the first pin base insulator perforated structure comprises a plurality of first pin base insulator perforated sub-structures distributed around the first pin base insulator through-hole structure.

3. The electrical connector of claim 2, wherein the plurality of first pin base insulator perforated sub-structures are individually separated from the first pin base insulator through-hole structure, and the separation distances among the plurality of first pin base insulator perforated sub-structures and the first pin base insulator through-hole structure are substantially equal.

4. The electrical connector of claim 2, wherein the plurality of first pin base insulator perforated sub-structures are separated from each other, and the separation distances among the plurality of first pin base insulator perforated sub-structures are substantially equal.

5. The electrical connector of claim 2, wherein the plurality of first pin base insulator perforated sub-structures are circular holes, elliptical holes, polygonal holes, fan-shaped holes, or irregularly shaped holes.

6. The electrical connector of claim 2, further comprising a pin base component waterproof gasket located between the pin base and the electrical connector body to prevent water from penetrating into the pin base internal space via the gap between the pin base and the electrical connector body.

7. The electrical connector of claim 1, wherein the pin base component further comprises a second pin base insulator, the second pin base insulator having a second pin base insulator through-hole structure, wherein the pin base is capable of accommodating the second pin base insulator, positioning the second pin base insulator within the pin base internal space, and allowing the pin to extend outward through the second pin base insulator via the second pin base insulator through-hole structure, wherein there exists a difference in dielectric coefficients between the first pin base insulator and the second pin base insulator, thereby enabling the pin to transmit signals with the expected return loss.

8. The electrical connector of claim 7, wherein the pin base component further comprises a third pin base insulator, the third pin base insulator comprising a third pin base insulator through-hole structure, wherein the pin base is capable of accommodating the third pin base insulator, positioning the third pin base insulator within the pin base internal space, and allowing the pin to extend outward through the third pin base insulator via the third pin base insulator through-hole structure, wherein there exists a difference in dielectric coefficients among the third pin base insulator, the first pin base insulator and the second pin base insulator, thereby enabling the pin to transmit signals with the expected return loss.

9. The electrical connector of claim 8, wherein the material of the first pin base insulator is HIPS (High impact polystyrene) with a dielectric coefficient of 2.5, wherein the material of the second pin base insulator is polytetrafluoroethylene with a dielectric coefficient of 2.1; and the material of the third pin base insulator is ABS (Acrylonitrile Butadiene Styrene) with a dielectric coefficient of 2.7.

10. The electrical connector of claim 1, configured to be used with a cable, further comprising a cable component, and the cable component comprises a cable base, and the cable base comprises a cable base internal space, wherein the cable base is joined to the electrical connector body and the cable is installed, allowing the cable to enter the electrical connector body from the cable base internal space and electrically connect to the pin to provide the signals.

11. The electrical connector of claim 10, wherein the cable base further comprises a cable base clamping structure, the cable base clamping structure clamps and positions the cable to achieve the installation of the cable.

12. The electrical connector of claim 10, further comprising a cable component waterproof gasket located between the cable base and the electrical connector body to prevent water from penetrating into the cable base internal space via the gap between the cable base and the electrical connector body.
